(19) United States
(12) Patent Application Publication
(10) Pub. No.: US 2008/0224075 A1
(43) Pub. Date: Sep. 18, 2008

(54) VARIABLE PRESSURE DROP AND/OR CLOSING AND SEALING DEVICES WITH INTERNAL CARTRIDGE AND MOBILE TUBE

(76) Inventor: Michel Emin, Ecully (FR)

Correspondence Address: BURR & BROWN, PO BOX 7068, SYRACUSE, NY, 13261-7068, US

(21) Appl. No.: 12/109,507

(22) Filed: Apr. 25, 2008

Related U.S. Application Data
(63) Continuation of application No. PCT/FR2006/002424, filed on Oct. 27, 2006.

(30) Foreign Application Priority Data
Oct. 28, 2005 (FR) FR 0511076

(51) Int. Cl. F16K 47/00

(52) U.S. Cl. 251/120

(57) ABSTRACT

Device for pressure drop, and/or closing and sealing a fluid circuit, with internal cartridge and mobile tube. The inventive device serves to produce a variable singular pressure drop on a line but also serves, optionally, to close and seal this line which may have a large diameter, at high pressure and at high temperature. In fact, via the movement of a mobile tube, the device of the invention serves to variably shut openings for the passage of the fluid transported in the line, this mobile tube may optionally create an autoclave seal on a closure seat at the end of travel. The torque required for operating the device is very low throughout the travel. Assembly and maintenance are simplified by the use of a removable cartridge immersed in the fluid containing almost all the members required for operating the device. It operates on all types of fluids.

### CROSS REFERENCE TO RELATED APPLICATIONS

This application is a continuation of International Application No. PCT/FR2006/002424, filed Oct. 27, 2006, and claims the benefit under 35 USC 119(a)-(d) of French Application No. 05.11076, filed Oct. 28, 2005, the entireties of which are incorporated herein by reference.

### FIELD OF THE INVENTION

The present invention describes a device for producing a variable pressure drop and/or for closing and sealing a seat suitable for use on circuits conveying gaseous or liquid fluids. Its aim is to produce a variable singular pressure drop on the line according to the travel of a mobile tube, very low at the start of travel and very high at the end of travel, or even an autoclave seal. This only requires a very low operating power.

The device applies to all functions that can be performed by all existing types of valves.

It is the object of the device to replace the valves existing today, by decreasing the power required for their operation and by improving the fluid flow.

### BACKGROUND OF THE INVENTION

Existing valves perform either a flow control function or a closure and sealing function. No device is available for performing both functions. Four major technological principles exist.

Seat valves consisting in the advance of a disk against a seat, parallel seat valves consisting in two disks sliding perpendicular to the fluid stream to bear against the seats at the end of travel, steel ball valves or parallel plug valves in which the closure is obtained by rotating the perforated core, and butterfly valves.

Seat valves have the advantage of being able to seal very high pressures and high temperatures. On the contrary, in this type of valve, the fluid must pass through the seat. The stem holding the disk bears against the seat, and the fluid flow either follows a Z-shaped route, or a right-angled route. This creates a disturbance of the flow and causes a pressure drop.

Parallel seat valves allow less disturbed fluid low. However, their design is unsuitable for the control function. The stream is highly disturbed during closure, the mechanism is complicated, and a quantity of fluid is retained between the two disks, so that, in case of depressurization, the valve is at best prevented from opening. Moreover, the friction of the disks against the seats during operations scratches the seats and damages the valve.

Full-flow valves are generally steel ball valves or parallel plug valves. These valves reconstitute the fluid stream entirely but have two drawbacks. The first is the difficulty of closing the valve perfectly between the upstream and downstream ends because the sealing surfaces rub against one another during the operations and are thereby scratched, making it impossible to prepare these valves for high pressure and high temperature applications. The second drawback is the high torque required for operating the valve because of the high friction of the sealing surfaces, making it a problem to produce these valves in large diameters, and making the control function very difficult. Furthermore, they generally have a retention zone.

Butterfly valves can be used as control members but are not very perfectly sealed. Moreover, the pressure drop is generated by the simple reduction of the fluid flow cross section and not by devices for varying the fluid route. The outgoing speeds are therefore very high. They cause a disturbance of the fluid stream and are subject to fluctuations.

The problem posed by the valves used today is that none of the existing products combines a control function with a closure and sealing function. Furthermore, the control ranges are often limited.

### SUMMARY OF THE INVENTION

The inventive device consists in producing a control valve generating a pressure drop that is very low when the valve is fully open and very high at the end of travel, and even an autoclave seal on a seat producing a good high pressure and high temperature seal while preserving a very low operating torque.

For this purpose, a support (2a), (2b), (2c), (2d), (2e) or (2f) is placed on a line, and a cartridge (3a), (3b), (3c), (3d), (3e) or (3f) containing almost all the members for operating the device, is fixed to the said support. The fluid passes via openings (6a) or (6b) through part of the cartridge (3a), (3b), (3c), (3d), (3e) or (3f). A mobile tube (5) variably shuts these openings (6a) or (6b) according to the desired pressure drop. Additional pressure drop devices can supplement the openings (6a) or (6b) and adapt the device to various flows. A closure seat is optionally placed at the end of travel.

The use of a mobile tube (5) as a disk decreases the masses to be moved and the pressure forces, and hence the power required to operate the device.

The device serves to produce control and closure valves regardless of the pressure and temperature, and with a very low pressure drop in the full open position.

The mobile control and closure member (5) may be lightweight, which is particularly advantageous for large diameters. It serves to select the autoclave bearing force by adjusting the position of the contact between the seat (4) and the mobile tube (5). The low weight of the moving members and the adjustment of the autoclave force generate a very low operating torque, hence requiring very small drive units.

This makes it possible to produce valves actuated by a self-contained generator. In fact, the low power required for operation can be generated from the fluid or from the external environment, stored, and then used by an actuator which may be remote-controlled by a transmitter. This represents for example a big advantage for application to oil pipelines, for which the application of the inventive device serves to eliminate the power supply wiring, which is sometimes several hundred kilometres long.

### BRIEF DESCRIPTION OF THE DRAWINGS

The inventive device will be better understood from a reading below, followed by several figures representing respectively:

FIG. 1 describes the application of the preferred device according to the invention shown in a cross section, in the “closed” position, that is when the device shuts off the passage of the fluid.

FIG. 2 shows an alternative of the inventive device without pressure drop device, in the “open” position, that is when the device allows the free passage of the fluid and imposes a minimal pressure drop thereon.

FIG. 3 shows an alternative of the inventive device, using a support (2c) of reduced size, a hydraulic drive device (19) and (22) and cylindrical openings (6b).

FIG. 4 shows an alternative of the inventive device, using a support (2d) permanently fixed to the line (1) and a self-contained (21) and (23) radio-controlled (24) drive device.

FIGS. 5a and 5b show enlarged views of FIG. 1 for a better understanding of the role of the stops (26).

FIG. 6 shows an alternative of the inventive device, using a support (2e) placed so as to carry the cartridge (3e) in a balanced manner and not with overhang.

FIG. 7 shows a left hand cross section view of the support (2e) used in FIG. 6.

FIG. 8 shows an alternative of the inventive device, using a support (2f) placed so as to carry the cartridge (3f) in a balanced manner and not with overhang. The tube (5) is outside the cartridge (3f).

FIG. 9 shows a left hand cross section of the support (2f) used in FIG. 8.

FIG. 10 shows an exploded view of an exemplary pressure drop device comprising an openwork support (7) and plates (33), (34), (35), (36) and (37).

FIG. 11 shows an exploded view of another exemplary pressure drop device comprising beads (39).

### DETAILED DETAILED DESCRIPTION OF THE INVENTION

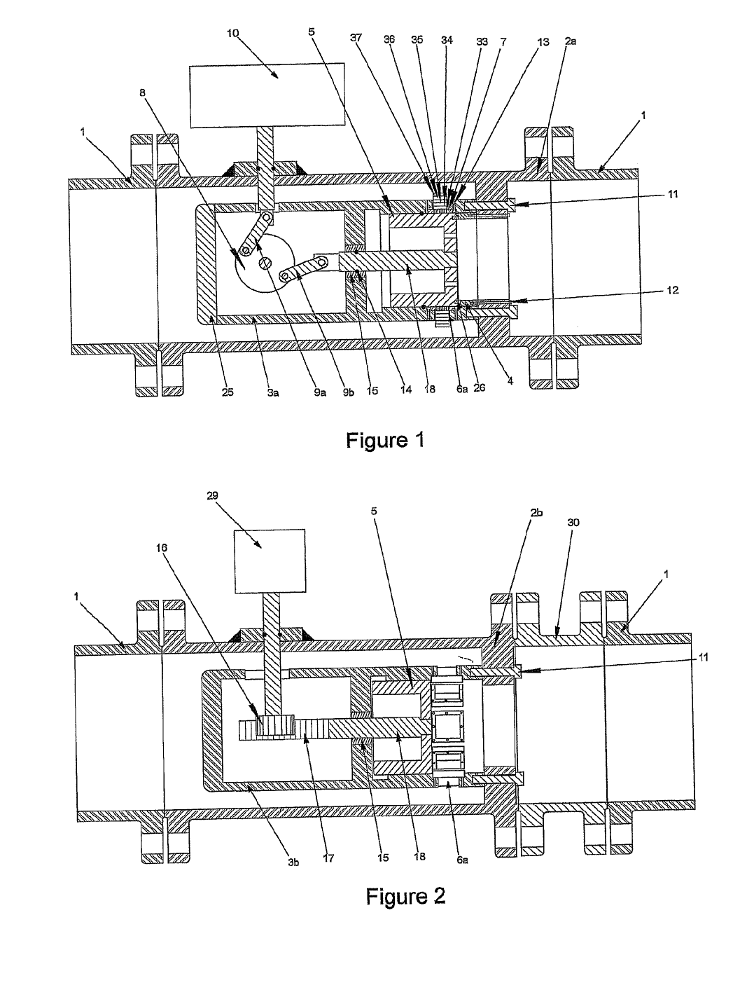

FIG. 1 shows the preferred application according to the invention in the closed position, that is blocking the passage of the fluid.

The invention consists of a device for producing a variable singular pressure drop and/or for closing and sealing between two parts of a fluid circuit. The invention is installed on a line (1).

It consists of a body (2a), fixed demountably here on the line (1), carrying, in overhang here, an internal cartridge (3a). The fastening is provided by screws (11).

This cartridge (3a) is, for the example, closed by a cover (25) which allows maintenance operations inside the cartridge (3a).

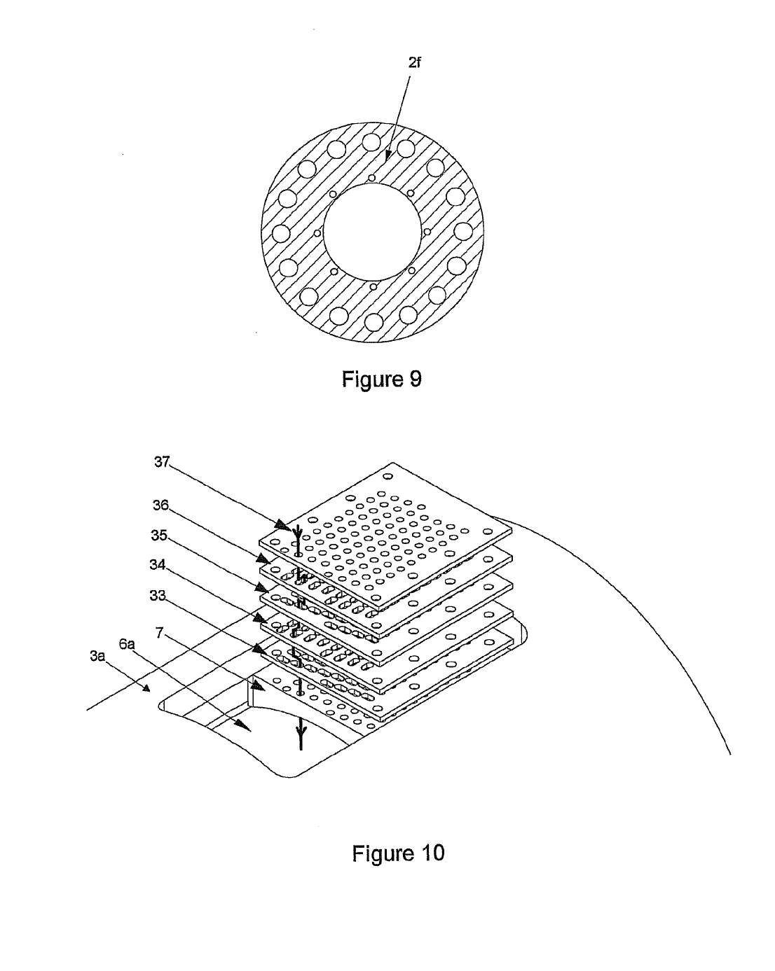

Openings (6a) are made through the cartridge (3a), the fluid passing through the said openings. These openings are, for the example, supplemented by pressure drop devices composed of a support (7) to which the plates (33), (34), (35), (36) and (37) are fixed. In passing through this pressure drop device, the fluid losses energy. FIG. 10 shows this pressure drop device in detail. The pressure drop device, in FIG. 1, is fixed for the example by screws (13) to the cartridge (3a). The various plates (33), (34), (35), (36) and (37) can be assembled and disassembled without complete removal of the valve. These plates can be adapted to a particular flow (type of fluid, flow rate, pressure, etc.).

The mobile tube (5), when it slides, variably shuts the opening (6a) and hence the pressure drop devices (7), thereby varying the singular pressure drop created by the device on the flow.

The shape of the openings (6a) can also be adapted according to the various applications.

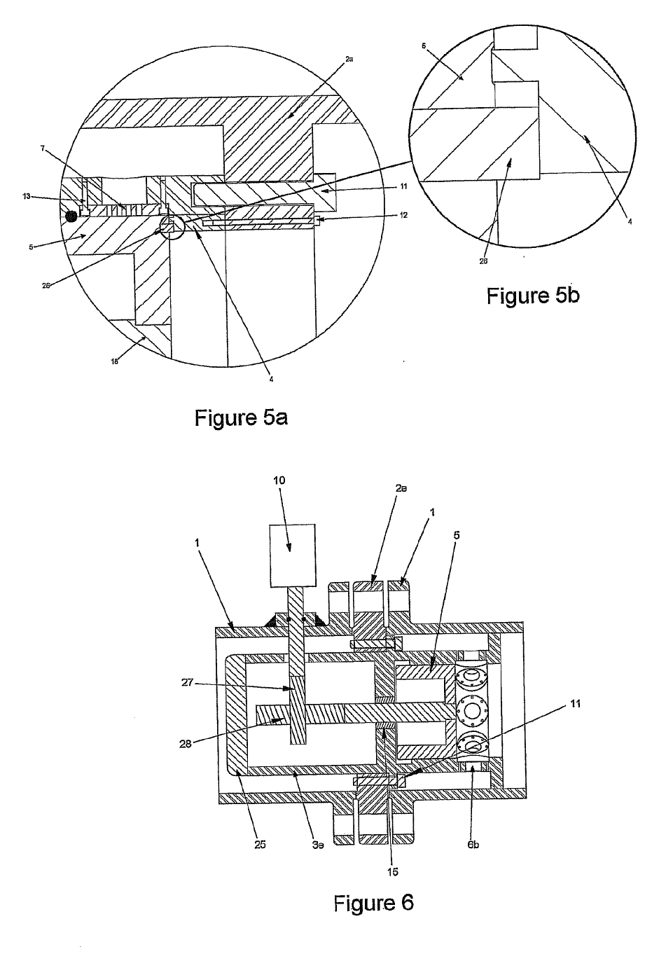

When the mobile tube (5) reaches the end of travel, it is in contact with a seat (4), fixed for the example to the support (2a) by screws (12). This contact creates a seal between the upstream and downstream ends of the device. Stops (26) limit the deformation of the contact between the seat (4) and the tube (5). FIGS. 5a and 5b show the role of the stops (26) in detail.

The seal thereby created is an autoclave seal, that is, the upstream pressure applies a force to the tube (5) in the closure direction. This force may be selected by the ratio of the areas of the tube (5) and its axis (18) subjected to the upstream and downstream pressure forces.

The tube (5) is thrust by a shaft (18) guided by a guide (15) and sealed by a seal (14).

The device for driving the shaft (18) is for the example a rod (9a) and (9b)—crank (8) system, pushed by an actuator (10).

This drive device has the advantage of being independent of the variations in positioning between the cartridge (3a) and the support (2a) due for example to the thermal expansion, to pressure forces or to the weight of the cartridge (3a).

When the actuator (10) is uncoupled from the rod-crank system, the entire cartridge (3a) and all the parts it carries, are demounted in a single block after removal of the screws (11).

FIG. 2 shows an alternative of the preferred application according to the invention in the open position, that is producing a minimal pressure drop on the flow.

The openings (6a) in the preferred application according to the invention and for the example are rectangular in shape and bare, and the movement of the mobile tube (5) varies the pressure drop generated on the fluid when it passes through the openings (6a).

The device for driving the tube (5) and its shaft (18) is a rack (17) driven by a pinion gear (16) coupled to an actuator (29).

A side opening flange (30) supplements the support (2b) and allows access into the line (1) and the inventive device without complete dismantling thereof.

The cartridge (3b) does not comprise a closing cover.

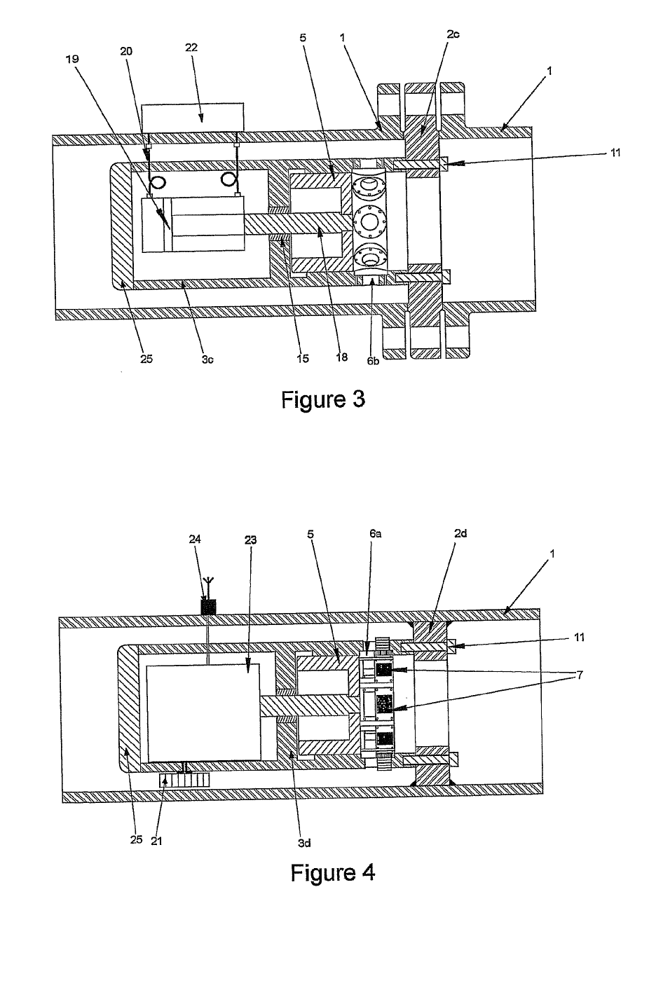

FIG. 3 shows an alternative application according to the invention in the open position.

The support (2c) is very small here and the cartridge (3c) is inside the line (1).

The device for driving the tube (5) and its shaft (18) is a cylinder (19) controlled by an actuator (22). The control fluid is conveyed in hoses (20), making the position of the cartridge (3c) independent of the line (1).

The openings (6b) are cylindrical for the example.

FIG. 4 shows an alternative application according to the invention in the open position.

The support (2d) is fixed permanently to the line (1). This support (2d) has a reduced size and is inside the line (1).

It supports the cartridge (3d) which carries a self-contained power generation device composed of a turbine (21) and a storage and actuation device (23).

The device can be radio-controlled by a radio-transmitter (24).

The drilled supports (7) of the pressure drop devices have a smaller size than the openings (6a). In the open position, this serves to generate only minimal pressure drops on the flow. When the tube (5) slides and begins to overlap the field supports (7), the pressure drop increases more rapidly. This arrangement therefore serves to create only a minimal pressure drop in full opening, and a higher pressure drop after a certain travel of the tube (5).

FIGS. 5a and 5b show enlarged use of the pressure drop and closure members of the device in FIG. 1. The plates (33), (34), (35), (36) and (37) are not shown here.

These figures offer a better understanding of the operation of the stops (26), which limit the deformation of the cylindrical contact between the seat (4) and the tube (5). In fact, the contact between the tube (5) and the seat (4) occurs over a small area and one or the other of the tube (5) or the seat (4) is prepared from a relatively soft material. In FIG. 5b, for the example, it is the tube (5) that is made from a relatively soft material and which is deformed. This produces a high deformation on the contact surface, which risks being damaged. This deformation is nevertheless desirable to ensure a good seal.

The stops (26), prepared from a relatively hard material, are virtually undeformed and therefore fix the maximum value of the deformation of the tube (5), by limiting the movement of the tube (5) with regard to the seat (4).

FIG. 6 shows an alternative of the application according to the invention in the open position.

The support (2e) carries the cartridge (3e) in a balanced manner and no longer with an overhang as in the previous figures.

The actuator (10) pushes a toothed part (27) which drives the tube (5) via a rack (28).

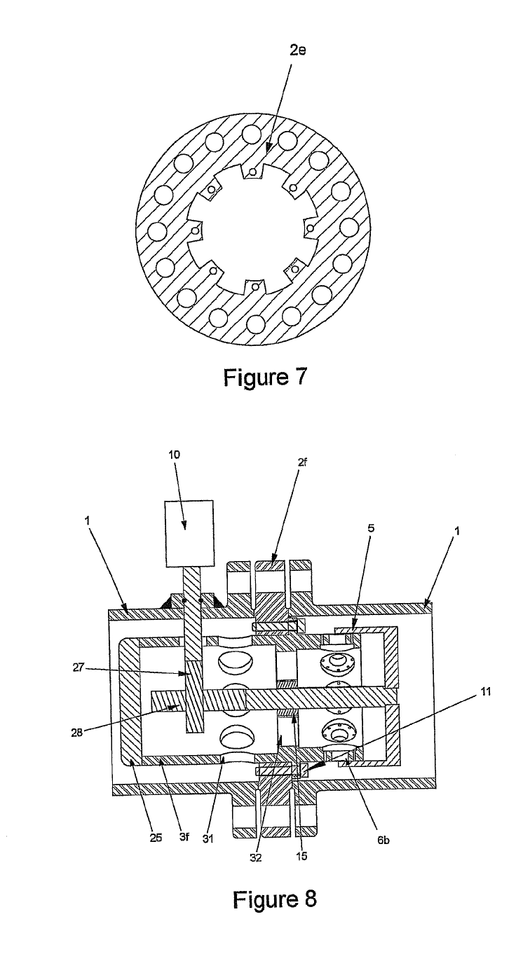

FIG. 7 shows a left hand cross section of the support (2e) shown in FIG. 6. Segments are cut out in order to allow the fluid to pass through.

FIG. 8 shows an alterative of the application according to the invention in the open position.

The support (2f) carries the cartridge (3f) in a balanced manner and no longer with an overhang as in the previous figures.

The tube (5) is outside the cartridge (3f). The support (2f) is solid and the fluid passes inside the cartridge (3f), via the openings (31), (32) and then (6b).

FIG. 9 shows a left hand cross section of the support (2f) shown in FIG. 8. This support (2f) is solid in order to force the fluid to pass through the openings (31), (32) and then (6b).

FIG. 10 shows details of an exemplary pressure drop device comprising a drilled support (7) and grooved or perforated grilles (33), (34), (35), (36) and (37), for the example, numbering five. The fluid path is shown by the bold arrow line.

The pressure drop is created by the passage through the grooves and the holes of the support (7) and the grilles (33), (34), (35), (36) and (37). The variation in the pressure drop coefficient of the application according to the invention is obtained by the shutting by the tube (5) of a variable number of holes on the drilled support (7).

The pressure drop device is also adaptable to a given flow (type of fluid, flow rate, pressure, etc.) by adjusting, when not in operation, the number and positioning of the holes and grooves on the support (7) and the grilles (33), (34), (35), (36) and (37), by varying the number and order of the grilles, and finally, by varying the general shape and nature of the grilles and the support (7). The number of pressure drop devices can also be adjusted because one or more pressure drop devices can be simply removed or replaced by a solid plate.

This serves, for example, to linearize the pressure drop according to the movement of the tube (5).

The control position corresponds to the positioning of the tube (5) opposite the support (7).

To allow the variation of the pressure drop in the open position (without control), the support (7) and the grilles (33), (34), (35), (36) and (37) can be replaced by elements of different sizes having the same function. This serves to adjust the minimal pressure drop when the device is in the open position. In FIG. 10, for the example, the support (7) and the grilles (33), (34), (35), (36) and (37) have a smaller size than the opening (6a) of the cartridge (3a). This arrangement allows control between zero and one hundred percent of the flow rate.

The assembly and disassembly of these pressure drop devices take place when not in operation and independently of one another, but without complete dismantling of the cartridge (3a). In fact, when the tube (5) is in the open position, the support (7) can be dismantled easily by removing the screws (13).

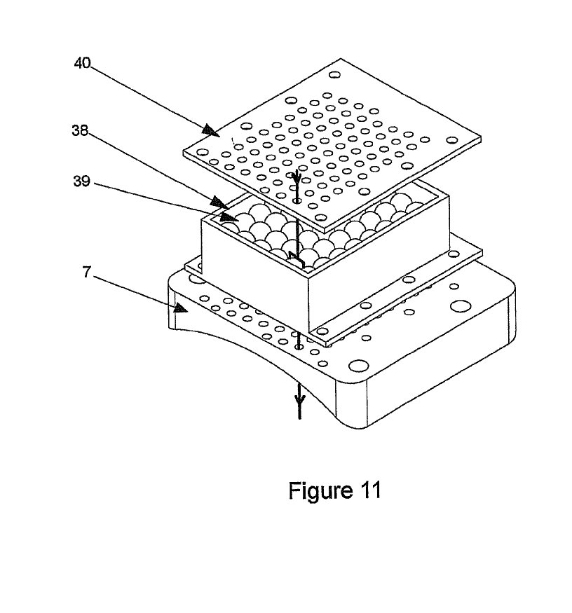

FIG. 11 shows details of another exemplary pressure drop device comprising a drilled support (7) to which a box (38) is fixed, filled with beads (39) and closed by an openwork plate (40). The fluid, when passing through the beads (39) as shown by the bold arrow line, loses energy.

The diameter of the beads (39) and the dimensions of the box (38) can be adjusted in order to vary the pressure drop generated on the fluid, to adapt the device to a given flow (type of fluid, flow rate, pressure, etc.) and optionally to linearize the pressure drop as a function of the movement of the tube (5).

What is claimed:

1. A device for producing a variable singular pressure drop on a line conveying a fluid, or for sealing the upstream or downstream end of this line, or both, comprising:
one or more fixed parts, designated in their support assembly;
one or more removable parts, designated in their cartridge assembly;
a mobile tube moving with regard to the cartridge and carried by the cartridge;
wherein the cartridge, containing all the elements necessary for operation, for variation of the flow rate, for variation of the pressure drop, or sealing, is fixed to the support and carried by part thereof projecting inwardly into the line,
wherein the mobile tube is capable of moving inside the cartridge;
wherein the support is itself an extension of the line or is connected to the line, the cartridge being inside this line or the support, and
wherein the cartridge guides the fluid in particular through openings drilled in the cartridge, which can be shut by the mobile tube.

2. The device according to claim 1, wherein the tube is actuated inside the cartridge by drive means independent of the variations of positioning between the cartridge and the support caused in particular by thermal expansion or pressure forces.

3. The device according to claim 2, wherein the means for driving the mobile tube is fixed to the cartridge.

4. The device according to claim 1, wherein the support or supports of the cartridge are removable with regard to the line.

5. The device according to claim 1, wherein the support or supports of the cartridge are fixed permanently to the line.

6. The device according to claim 1, wherein all or part of the openings for the passage of the fluid into the cartridge are supplemented by pressure drop members that totally or partially supplement the openings.

7. The device according to claim 6, wherein the pressure drop member or members supplementing the openings for passage of the fluid into the cartridge can be assembled and disassembled without removing the cartridge from the support.

8. The device according to claim 6, wherein the pressure drop produced by the member on the fluid is variable via the variation in the shape, number, dimensions or nature of the pressure drop members supplementing the openings for passage of the fluid into the cartridge.

9. The device according to claim 6, wherein the pressure drop produced by the device on the fluid is mainly created by the passage of the fluid through a stack of openwork plates, each plate constituting part of the route to be travelled by the fluid, and characterized in that the pressure drop is modified by the modification of the fluid route obtained by varying the order, the number or the shape of the holes of the various plates, constituting the stack.

10. The device according to claim 6, wherein the pressure drop produced by the device on the fluid is mainly created by the passage of the fluid through a box containing elements which may have varied sizes or geometric shapes, for example beads, each element constituting an obstacle that the fluid must circumvent, and characterized in that the pressure drop is modified by the modification of the fluid route obtained by varying the order, the number or the shape of the elements.

11. The device according to claim 1, wherein the device comprises a closure seat.

12. The device according to claim 11, wherein the mobile tube serves as a controlling member and a sealing member between the upstream and downstream ends of the device when it is in contact with the closure seat.

13. The device according to claim 11, further comprising stops limiting the deformation of the contact between the mobile tube and the closure seat.

14. The device according to claim 11, wherein the force for closing the device is variable, via the variation in the position of the contact between the closure seat and the mobile tube.

15. The device according to claim 1, wherein the axis of the cartridge is colinear with the axis of the line.

16. The device according to claim 1, wherein the cartridge is fixed to the support with an overhang.

17. The device according to claim 1, wherein the cartridge is fixed to the support in a balanced manner.
